(19) United States
(12) Patent Application Publication
(10) Pub. No.: US 2013/0086471 A1
(43) Pub. Date: Apr. 4, 2013

(54) Workflow integration and management of presentation options

(71) Applicant: Kenneth B. Moore, Seattle, WA (US)

(72) Inventor: Kenneth B. Moore, Seattle, WA (US)

(21) Appl. No.: 11/703,392

(22) Filed: Feb. 7, 2007

(51) Int. Cl. G06F 17/24

(52) U.S. Cl. CPC G06F 17/24
USPC 715/269; 715/256

(57) ABSTRACT

A content editor application enables a computer user to manage storage and application of presentation options (e.g., font styles) in the context of editing content on a corresponding display screen. For example, the computer user can create a folder using functionality provided by the content editor application. In response to receiving input such as a selection (by the computer user) of a subset of presentation options chosen from a listing of available presentation options, the content editor application stores identities of selected presentation options in the folder. Accordingly, while editing content on a respective display screen, a computer user can create different folders for storing selected fonts. Upon further input from a computer user, the content editor application enables viewing of font styles in one or more previously created folders and selective application of the presentation options to content currently being edited on a display screen.

### BACKGROUND

Use of editors has become quite common in conventional computer applications. One reason for such a broad acceptance of text editors is the convenience afforded by their use.

For example, via use of a window-based application such as a text editor, a computer user can open a “window” on a computer screen and modify the contents of a file such as a text-based document. Typically, text editor applications enable a user to select text in a document and thereafter apply text editing or formatting commands such as bolding, italicizing, underlining, copying, pasting, formatting, etc.

One type of editing function is font selection. In the context of most editor applications, font selection typically involves selection of an active font type (from a pull-down menu) for application to a text string. Based on selection from a menu of different font options, a respective computer user is able to easily change a corresponding font style of content being edited according to his/her preference. As mentioned above, after selection of a particular type of font, the user can apply other formatting commands (e.g., size, bold, italicize, etc.) to change an appearance of the content being edited.

Management of fonts typically requires use of a font manager application (which is a management application operating separate from the content editor application) to activate and deactivate fonts with a corresponding operating system. Registering fonts with an operating system “activates” a font so that the font can be “seen” by any editor applications being launched by the operating system.

Keeping too many fonts (e.g., thousands of fonts) activated at the same time can slow down a computer and potentially cause font corruption. Accordingly, a font manager program can be used to limit the number of fonts activated at any given time.

### SUMMARY

As mentioned above, conventional content editor applications enable a user to view and apply different types of active fonts to content being edited on a display screen. Typically, the active fonts can be viewed in a pull-down menu on the content editor application. Aside from selection of options from a pull-down, content editor application do not provide efficient ways to manage storage and application of fonts to content being edited on a display screen.

Techniques discussed herein deviate with respect to conventional applications such as those discussed above as well as other techniques known in the prior art. For example, certain embodiments herein are directed to overcoming deficiencies associated with the above-mentioned techniques and/or other deficiencies in the prior art not mentioned above.

In a general embodiment, a content editor application enables modification of content displayed on a display screen. In response to receiving a command to view different selectable presentation options (e.g., font styles) for modifying content being edited on the display screen, the content editor application initiates display of one or more folders of fonts managed by a respective computer user. Upon selection of a particular folder, the content editor application initiates display of a listing of the different selectable presentation options (e.g., different font types) in the selected folder. The folders and corresponding listing of presentation options in the selected folder can be presented for viewing in a same dialog box.

As the computer user selects different folders, the computer user can view the different presentation options in each of the folders and selectively apply the presentation options to content being edited on a display screen. The content editor application can provide a sample view of how the content on the display screen would appear if a corresponding presentation option in a selected folder were applied to the content on the display screen. Thus, a respective user can view (in a management window such as a dialog box) how the content would appear prior to actual application of a given font to the content being edited on the display screen.

In one embodiment, the computer user can manage fonts (e.g., presentation options) in the context of a workflow. For example, the computer user can initiate use of a font management function while editing content on a corresponding display screen. In response to receiving a selection of a subset of presentation options chosen from a listing of available presentation options in a displayed management window, the content editor application can create and/or maintain a folder to track identities of presentation options associated with the selection presentation options for inclusion in the folder. Accordingly, in the context of graphical user interface enabling application of different font styles to content being edited on the display screen, the respective computer user can create different folders for storing selected fonts as well as select a folder for applying different font styles to content being edited on a display screen. In addition to enabling creation, deletion, and modification of folders, the computer user can apply presentation options in a selected folder to content on a display screen.

Embodiments herein contrast with conventional applications. For example, a listing produced by the content editor application and displayed in a management window on the display screen enables selection and application of fonts (e.g., presentation options) stored in computer user created and managed folders. This eliminates the need for the computer user to leave a current editor application to launch and operate a third party management tool to manage available fonts. Accordingly, a respective computer user can easily access and therefore manage fonts via novel functionality provided by a corresponding content editor application.

Note that embodiments herein can include a content editor application and/or computer system configured to carry out and/or support any or all of the method operations disclosed herein. In other words, one or more computerized devices, processors, and/or software applications can be programmed and/or configured to operate as explained herein to carry out different embodiments of the invention.

Yet other embodiments herein include software programs to perform the steps and operations summarized above and disclosed in detail below. One such embodiment comprises a computer program product that has a computer-readable medium including computer program logic encoded thereon that, when performed in a computerized device having a processor and corresponding memory, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained herein.

Accordingly, one particular embodiment of the present disclosure is directed to a computer program product that includes a computer readable medium having instructions stored thereon for supporting operations such as enabling editing functions and/or activation and deactivation of different presentation options (e.g., fonts). The instructions, when carried out by a processor of a respective computer device, cause the processor to: i) initiate display of available presentation options for selective application to content currently being edited on a display screen; ii) receive selection of a subset of presentation options chosen from the available presentation options; and iii) maintain a folder to track identities of presentation options associated with the selection. The numbering of the steps has been added for clarity sake; these steps may not need to be in the particular order as discussed above.

Other embodiments of the present disclosure include software programs to perform any of the method embodiment steps and operations summarized above and disclosed in detail below.

Also, it is to be understood that the system, method, apparatus, etc. herein can be embodied strictly as a software program, as a hybrid of software and hardware, or as hardware alone such as within a processor, or within an operating system or a within a software application. Although not necessary, example embodiments of the invention may be implemented within products and/or software applications such as those manufactured by Adobe Systems, Inc. of San Jose, Calif., USA.

As discussed above, techniques herein are well suited for use in management of fonts and different workflow applications. However, it should be noted that embodiments herein are not limited to use in such applications and that the techniques discussed herein are well suited for use in other applications as well.

Note that each of the different features, techniques, configurations, etc. discussed herein can be implemented independently or in combination with each other. Accordingly, the present invention can be embodied and viewed in many different ways.

Also note that this summary section herein does not specify every embodiment and/or incrementally novel aspect of the present disclosure or claimed invention. Instead, this summary only provides a preliminary discussion of different embodiments and corresponding points of novelty over conventional techniques. For additional details and/or possible perspectives (permutations) of the invention, the reader is directed to the Detailed Description section and corresponding figures of the present disclosure as further discussed below.

### BRIEF DESCRIPTION OF THE DRAWINGS

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles and concepts.

FIG. 1 is a diagram of a computer environment illustrating use of a content editor application and corresponding management functionality according to embodiments herein.

FIG. 2 is an example of a computer environment and corresponding computer system for executing a content editor application and related functions according to embodiments herein.

FIG. 3 is a flowchart illustrating a technique enabling management of groupings of presentation options according to embodiments herein.

FIGS. 4 and 5 combine to form a flowchart illustrating different types of functionality provided by a content editor application according to embodiments herein.

FIG. 6 is a flowchart illustrating display and use of a management window in the context of a workflow according to embodiments herein.

FIG. 7 is a flowchart illustrating functionality associated with a content editor application according to embodiments herein.

FIGS. 8-24 are screenshots illustrating different functionality associated with a content editor application according to embodiments herein.

### DETAILED DESCRIPTION

According to an example embodiment, a content editor application enables a computer user to manage storage and application of presentation options (e.g., font styles) in the context of editing content on a corresponding display screen. For example, the computer user can create a folder using functionality provided by the content editor application. In response to receiving input such as a selection (by the computer user) of a subset of presentation options chosen from a listing of available presentation options, the content editor application stores identities of selected presentation options in the folder. Accordingly, while editing content on a respective display screen, a computer user can create different folders for storing selected fonts. Upon further input from a computer user, the content editor application enables viewing the different presentation options stored in one or more previously created folders and selective application of the presentation options to content currently being edited on a display screen.

Additional functionality associated with the content editor application is discussed in more detail below and as presented in accompanying figures.

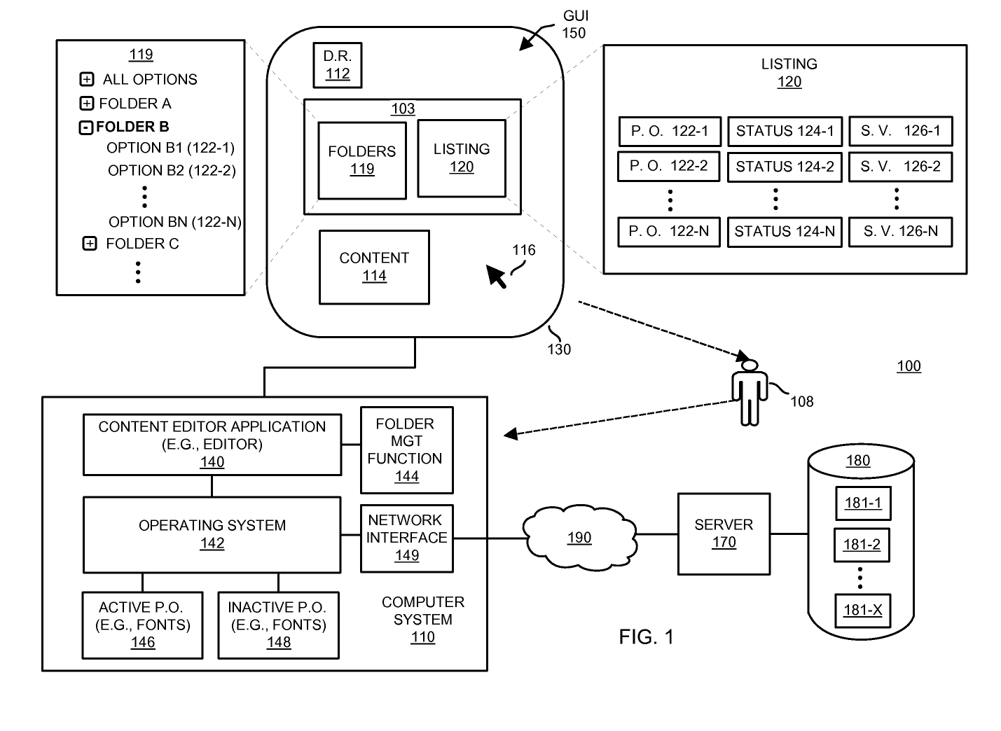

FIG. 1 is a diagram of a computer environment 100 supporting execution of and functionality associated with content editor application 140 according to an embodiment herein.

As shown, computer environment 100 includes computer system 110, display screen 130, network 190 (e.g., the Internet, private local area network, public network, wide area network, etc.), server 170, and repository 180. Computer system 110 includes content editor application 140, operating system 142, folder management function 144 (to keep track of folders 119), network interface 149 (to communication over network 190), available presentation options such as active presentation option 146 (e.g., files enabling presentation of active font styles), inactive presentation options 148 (e.g., files enabling presentation of inactive font styles), and network interface 149. Repository 180 stores additional presentation options such as files 181 or functional code enabling presentation of different respective font styles.

Display screen 130 supports presentation of display region 112 (e.g., a selectable icon or toggle button), content 114 (e.g., text strings, images, etc. of information currently being edited on display screen 130), and management window 103. Content editor application 140 populates management window 103 (e.g., a dialog box, pop-up window, etc.) to include folders 119 (of presentation options) as well as listing 120. Folders 119 can be displayed as a hierarchical tree including directories and sub-directories for keeping track of different presentation options. As an alternative to a tiered structure, the hierarchy of folders 119 can be a flat structure of selectable folders.

Each of folders 119 can specify presentation options (e.g., fonts or corresponding files supporting different font styles) stored in computer system 110 or presentation options stored at a remote location (e.g., repository 180) over a network 190. Listing 120 can display different presentation options 122 (e.g., presentation option 122-1, presentation option 122-2, . . . , presentation option 122-N), status information 124 (e.g., status information 124-1, status information 124-2, . . . , status information 124-N), and sample views 126 (e.g., sample view 126-1, sample view 126-2, . . . , sample view 126-N) for a selected folder from folders 119. In other words, an example row in listing 120 can identify a presentation option 122 by name (e.g., indicating a respective font style), a status of the font style such as whether the font style identified in the row is active or inactive, and sample view 126 for displaying unique features associated with the font style.

Computer user 108 can launch corresponding content editor application 140 to present graphical user interface 150 on display screen 130. The computer user 108 navigates about graphical user interface 150 and provides commands via prompt 116 (e.g., a user controlled arrow, cursor, etc. that enables application of commands and selection of items appearing in graphical user interface 150) to manage resources such as fonts and apply different presentation options to content 114 on display screen 130.

As mentioned, the graphical user interface 150 presented by content editor application 140 enables modification of content 114 displayed on display screen 130. For example, via prompt 116, a computer user 108 can initially select all or a portion of content 114 (e.g., text) for modification. Thereafter, the computer user 108 can click on display region 112 (e.g., a toggle button) to initiate display of a respective dialog box (e.g., management window 103) including folders 119 and listing 120. Clicking on display region 112 is basically a command input by computer user 108 to display management window 103 (e.g., a dialog box) including listing 120 that presents different editing options (e.g., presentation options 122) for selectively applying to all or part of content 114.

In response to receiving input such as clicking on display region 112 to view different selectable presentation options (e.g., font styles), the content editor application 140 initiates display of management window 103. Upon selection of a folder in folders 119, the content editor application can expand the folder to display the presentation options stored in the folder. Additionally, the content editor application 140 can populate listing 120 to view more information about the different presentation options in a given folder. For example, suppose the user selects folder B as shown in FIG. 1. In response to the selection, the content editor application 140 expands folder B and initiates display of each presentation option (e.g., presentation option 122-1, presentation option 122-2, . . . presentation option 122-N) locally beneath folder B. Accordingly, the computer user 108 can quickly view the different options in a selected and/or expanded folder.

Content editor application 140 can also populate listing 120 with details associated with the presentation options in a selected folder. For example, listing 120 in FIG. 1 includes detailed information associated with the different options in folder B. Upon further input from the computer user 108 such as selection from listing 120 of presentation options associated with folder B (or other selected folder as the case may be), the content editor application can apply a selected presentation option in listing 120 to content 114 being edited on display screen 130.

In the context of the present example, each row in listing 120 can include a display of a presentation option 122 as well as corresponding status information 124 and a sample view 126. The presentation option 122 can be an identifier (e.g., an associated font name) indicating a selectable font style. The status information 124 can indicate whether the font style is active, inactive, available on-line for purchase, etc. The sample view 126 can illustrate how selected content will appear in content 114 based on application of the corresponding presentation option 122.

In addition to enabling selective application of presentation options to content 114 on display screen 130, the content editor application 140 can enable the computer user 108 to add folders, delete folders, and manage the content of folders 119 via folder management function 144 and graphical user interface 150. To add presentation options to a given folder, the computer user can utilize prompt 116 to drag and drop a presentation option 122 from listing to any of folders 119 in management window 103. Other functions such as cut and paste can be used to modify content of folders as well. Accordingly, the computer user can customize storage of different groupings or sets of presentation options 122 according to his or her needs. Additional functionality associated with the content editor application 140 and corresponding management window 103 will be discussed later in this specification.

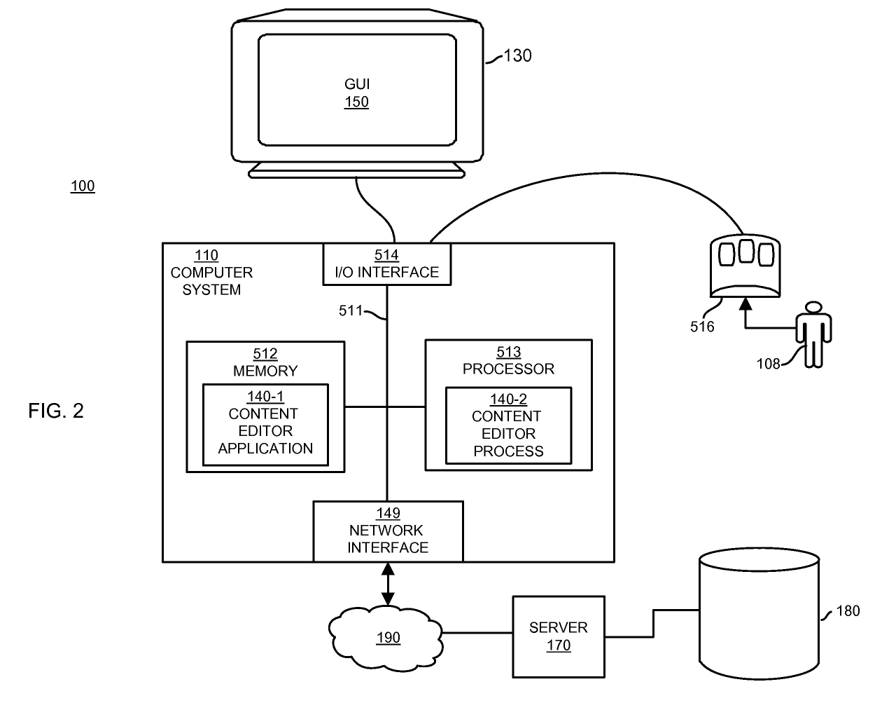

FIG. 2 is a block diagram of a computer environment 100 illustrating an example architecture of a respective computer system 110 for implementing content editor application 140 and related functionality according to embodiments herein. Computer system 110 can be a computerized device such as a personal computer, workstation, portable computing device, console, network terminal, processing device, etc.

As shown, computer system 110 of the present example includes an interconnect 511 that couples a memory system 512, a processor 513 (e.g., one or more processors), I/O interface 514, and a network interface 149. I/O interface 514 provides connectivity to peripheral devices 516 such as a keyboard, a mouse for controlling movement of prompt 116 on display screen 130, etc. User 108 provides input to computer system 110. Network interface 149 enables computer system 110 to communicate over network 190 to retrieve and transmit information (e.g., font files) from remotely located sources such as those stored in repository 180.

As shown, memory system 512 is encoded with content editor application 140-1 that supports management of fonts, folders, etc. as well as other functionality as discussed above and as discussed further below. Content editor application 140-1 can be embodied as software code such as data and/or logic instructions (e.g., code stored in the memory or on another computer readable medium such as a disk) that supports processing functionality according to different embodiments described herein.

During operation according to one embodiment, processor 513 accesses memory system 512 via the use of interconnect 511 in order to launch, run, execute, interpret or otherwise perform the logic instructions of the content editor application 140-1. Execution of the content editor application 140-1 produces processing functionality in content editor process 140-2. In other words, the content editor process 140-2 represents one or more portions of the content editor application 140-1 performing within or upon the processor 513 in the computer system 110 or displayed as graphical user interface 150 on display screen 130.

It should be noted that, in addition to the content editor process 140-2 that carries out method operations as discussed herein, other embodiments herein include the content editor application 140-1 itself (i.e., the un-executed or non-performing logic instructions and/or data). The content editor application 140-1 may be stored on a computer readable medium such as a floppy disk, hard disk, optical medium, etc. According to other embodiments, the editor application 140-1 can also be stored in a memory type system such as in firmware, read only memory (ROM), or, as in this example, as executable code within the memory system 512 (e.g., within Random Access Memory or RAM).

In addition to these embodiments, it should also be noted that other embodiments herein include the execution of content editor application 140-1 in processor 513 as the content editor process 140-2. Thus, those skilled in the art will understand that the computer system 110 can include other processes and/or software and hardware components, such as an operating system that controls allocation and use of hardware resources.

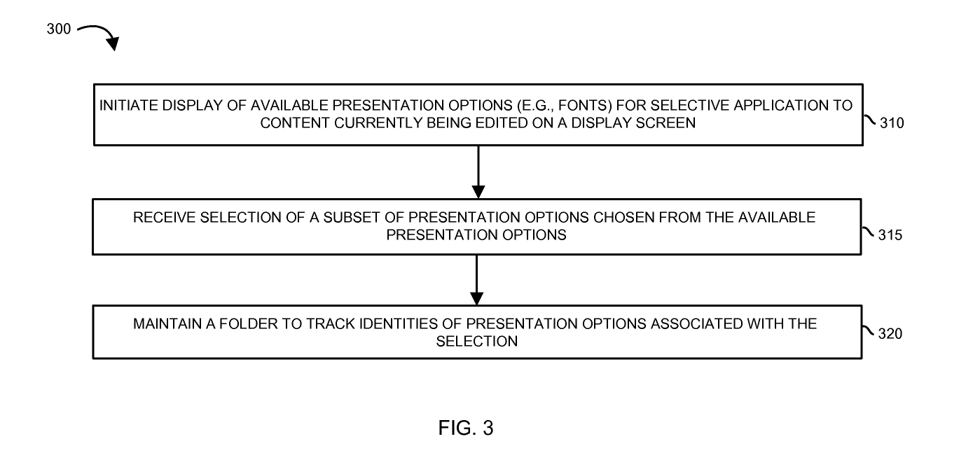

Functionality supported by computer system 110 and, more particularly, functionality associated with editor application 140-1 and editor process 140-2 will now be discussed via flowcharts in FIGS. 3 through 7. For purposes of the following discussion, computer system 110, content editor application 140 (e.g., content editor application 140-1 and/or content editor process 140-2), management window 103, etc. generally performs steps in the flowcharts.

Note that there will be some overlap with respect to concepts discussed above for FIGS. 1 and 2. Also, note that the steps in the below flowcharts need not always be executed in the order shown.

Now, more particularly, FIG. 3 is a flowchart 300 illustrating a technique of previewing different types of presentation options according to an embodiment herein. Flowchart 300 of FIG. 3 will make reference to matter previously discussed above.

In step 310, the content creation application 140 initiates display of available presentation options 122 (e.g., fonts) for selective application to content 114 currently being edited on a display screen 130.

In step 315, the content creation application 140 receives selection of a subset of presentation options 122 chosen from a set of available presentation options such as those presented in listing 120.

In step 320, the content creation application 140 maintains a folder (e.g., one of folders 119) to track identities of presentation options 122 associated with the selection.

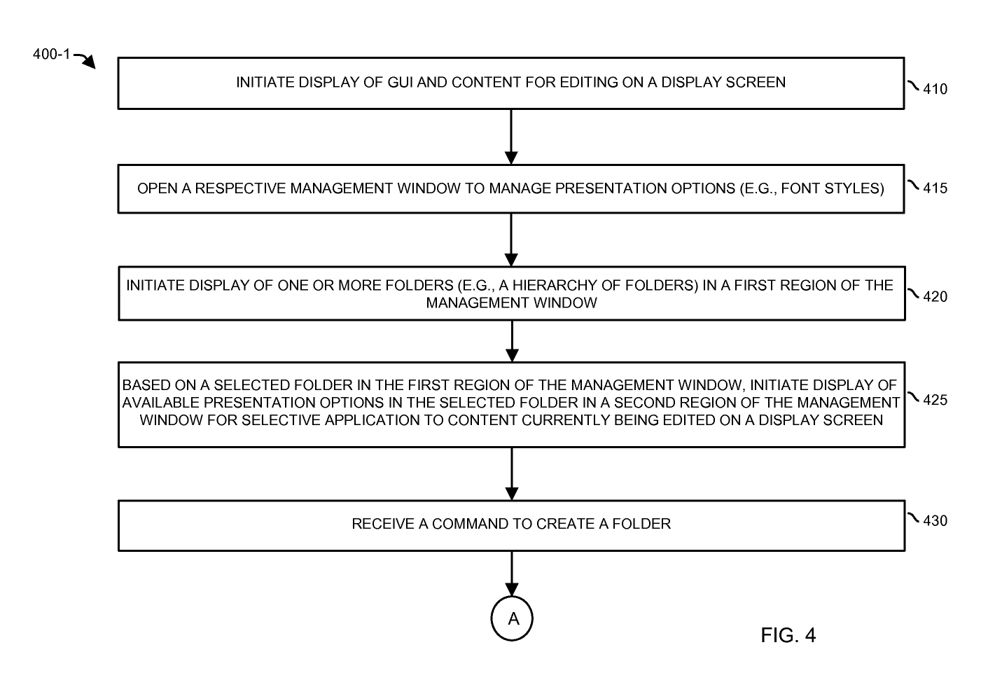

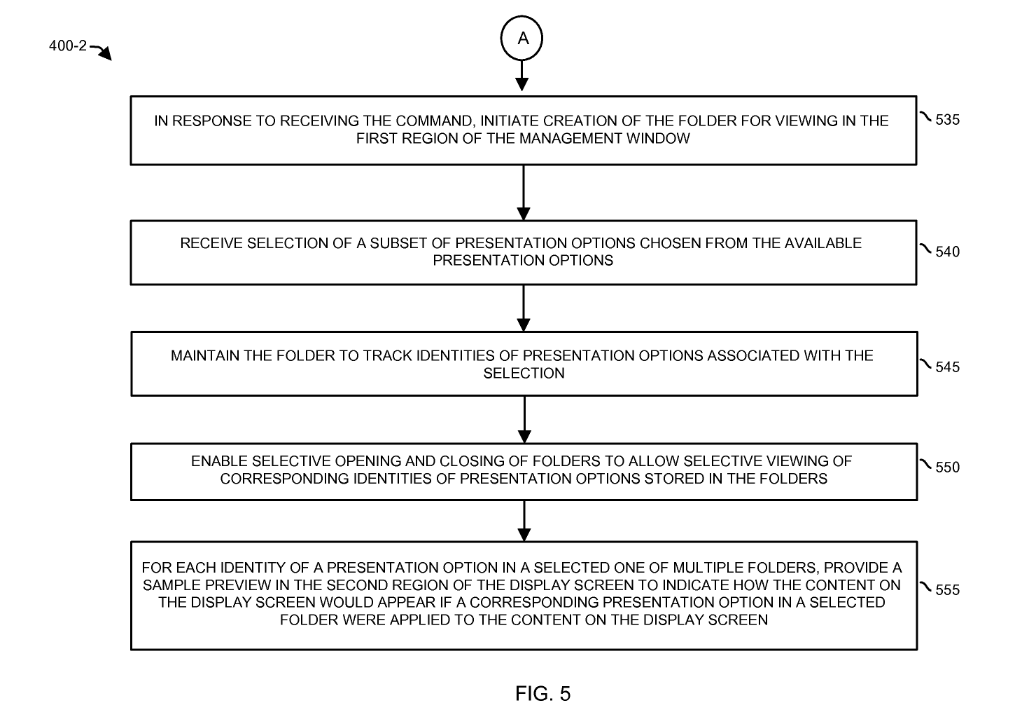

FIGS. 4 and 5 combine to form flowchart 400 (e.g., flowchart 400-1 and flowchart 400-2) illustrating more specific techniques associated with embodiments herein. Note that according to the present example embodiment, the steps in flowcharts 400-1 and flowchart 400-2 (collectively, flowchart 400) are carried out by a processing entity such as content editor application 140. However, note that the type of entity that executes these operational steps can vary depending on the application.

In step 410 of FIG. 4, the content editor application 140 initiates display of graphical user interface 150 and content 114 for editing on display screen 130.

In step 415, the content editor application 140 opens a respective management window (e.g., management window 103) to manage presentation options (e.g., font styles).

In step 420, the content editor application 140 initiates display of one or more folders 119 (e.g., a hierarchy of folders) in a first region of the management window 103.

In step 425, based on a selected one of the multiple folders 119 in the first region of the management window 103, the content editor application 140 initiates display of available presentation options 122 of the selected folder in a second region (e.g., listing 120) of the management window 130 for selective application to content 114 currently being edited on a display screen 130.

In step 430, the content editor application 140 receives a command to create a new folder.

In step 535 of FIG. 5, in response to receiving the command, the content editor application 140 initiates creation of the folder for viewing in the first region of the management window 103 along with folders 119.

In step 540, the content editor application 140 receives selection of a subset of presentation options 122 chosen from the available presentation options in the listing 120. The selection can include a single selection at one time or a number of selections at different times.

In step 545, the content editor application 140 maintains the new folder along with pre-existing folders to track identities of presentation options associated with the selection.

In step 550, the content editor application 140 enables selective opening and closing of folders 119 (including the newly created folder) to allow selective viewing of corresponding identities of presentation options stored in the folders 119.

In step 555, for each identity of a presentation option in a selected one of multiple folders 119, the content editor application 140 provides a sample preview in the second region (e.g., listing 120) of the display screen 130 to indicate how the content on the display screen would appear if a corresponding presentation option in a selected folder were applied to the content 114.

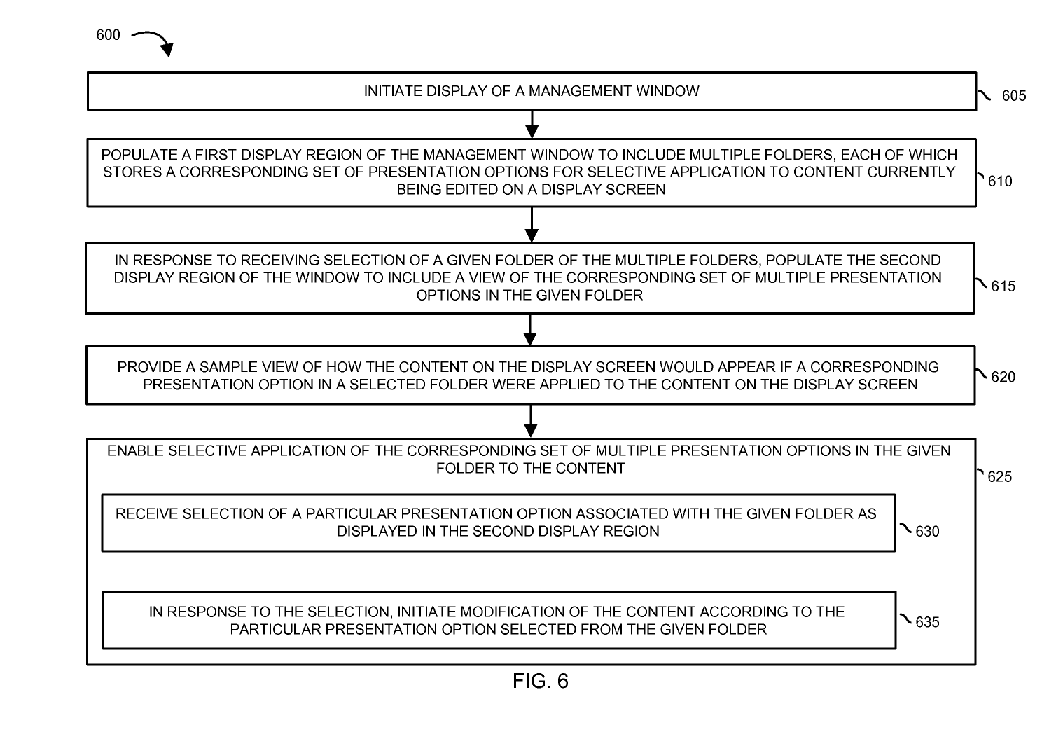

FIG. 6 is a flowchart 600 illustrating use of management window 103 according to embodiments herein. Note that flowchart 600 of FIG. 6 will make reference to matter previously discussed above.

In step 605, the content editor application 140 initiates display of a management window 103 on a display screen 130.

In step 610, the content editor application 140 populates a first display region of the management window 103 to include multiple folders 119, each of which tracks a corresponding set of presentation options for selective application to content 114 currently being edited on a display screen 130.

In step 615, in response to receiving selection of a given folder of the multiple folders 119 in management window 103, the content editor application 140 populates the second display region (e.g., region displaying folders 119) of the management window 103 to include a view of the corresponding set of multiple presentation options in a selected folder of the multiple folders 119.

In step 620, the content editor application 140 provides a sample view of how the content on the display screen 130 would appear if a corresponding presentation option 122 in a selected one of the multiple folders were applied to the content 114 on the display screen 130.

In step 625, the content editor application 140 enables selective application of the corresponding set of multiple presentation options in the selected folder to the content 114.

In step 630, the content editor application 140 receives selection of a particular presentation option associated with the selected folder as displayed in the right hand panel (e.g., listing 120) of management window 103.

In step 635, in response to the selection, the content editor application 140 initiates modification of the content 114 according to the selected presentation option in the currently selected folder.

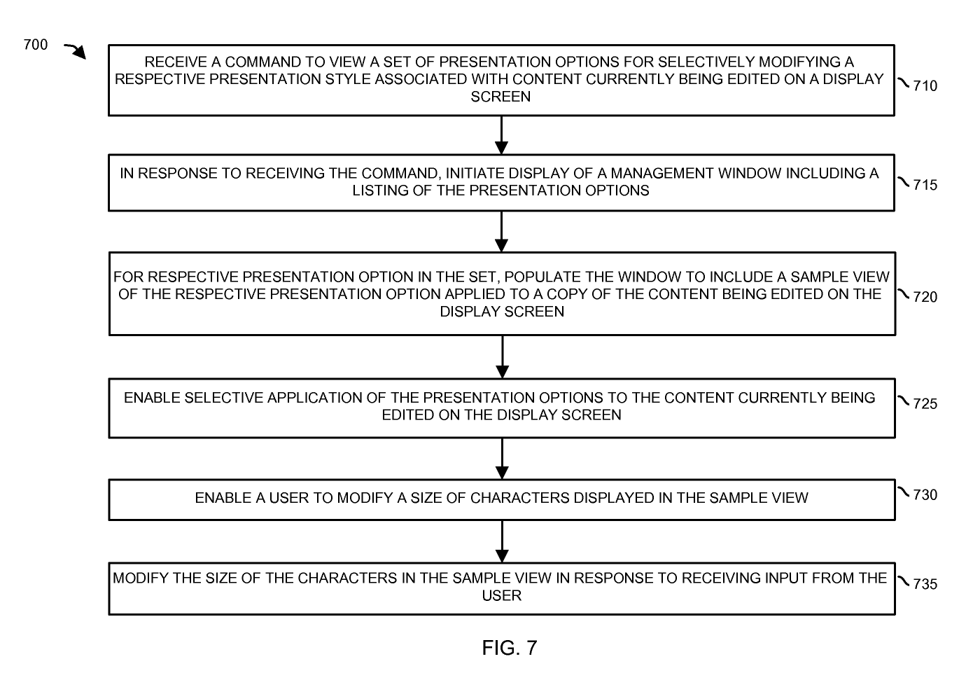

FIG. 7 is a flowchart 700 illustrating additional functionality supported by content editor application 140 according to embodiments herein. Note that flowchart 700 of FIG. 7 will make reference to matter previously discussed above.

In step 710, the content editor application 140 receives a command to view a set of presentation options for selectively modifying a respective presentation style associated with content 114 currently being edited on a display screen 130.

In step 715, in response to receiving the command, the content editor application 140 initiates display of a management window 103 including a listing of the presentation options.

In step 720, for a respective presentation option in the set, the content editor application 140 populates the listing 120 in management window 103 to include a sample view of the respective presentation option applied to a copy of the content being edited on the display screen or other selected content.

In step 725, the content editor application 140 enables selective application of the presentation options to the content 114 currently being edited on the display screen 130.

In step 730, via input with respect to graphical user interface 150, the content editor application 140 enables a user 108 to modify a size of characters displayed in the sample view 126.

In step 735, the content editor application 140 modifies the size of the characters in the sample view 126 in response to receiving input from the user 108.

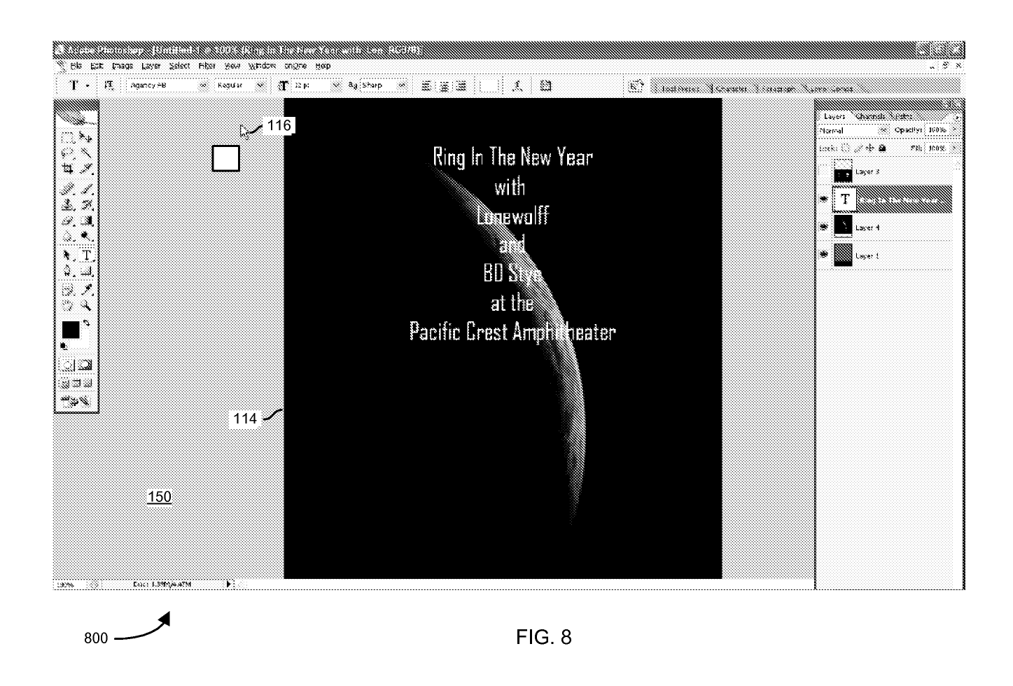

FIG. 8 is a screenshot 800 illustrating an example of graphical user interface 150 supported by content editor application 140 according to embodiments herein. As shown, a respective computer user 108 uses mouse-controlled prompt 116 to select and apply different editing functions to content 114.

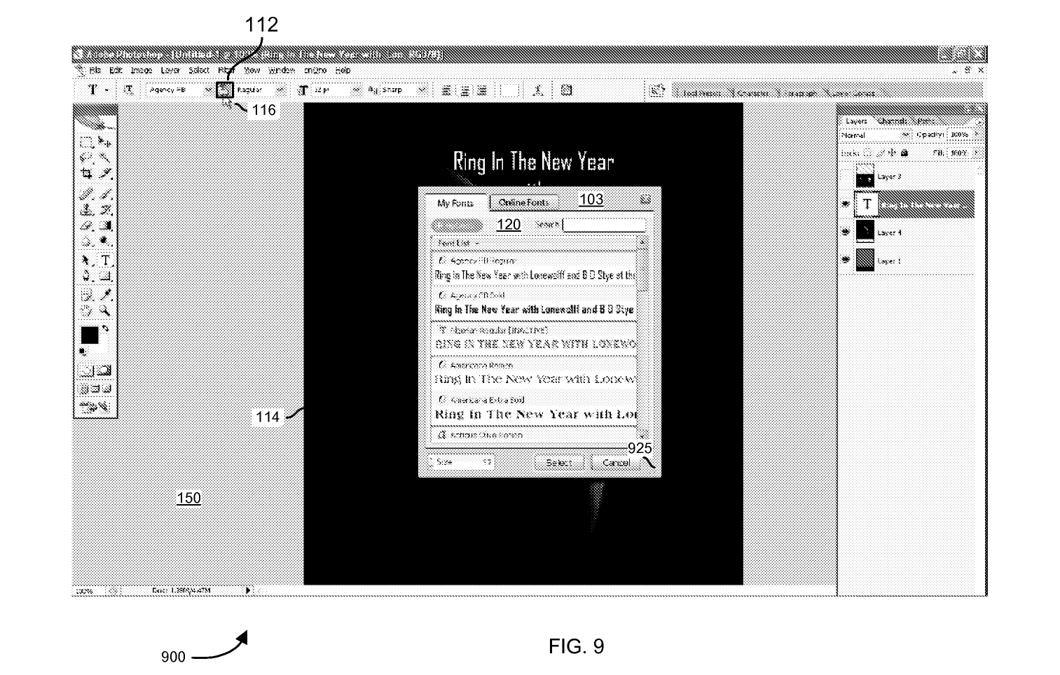

FIG. 9 is a screenshot 900 illustrating an example of graphical user interface 150 supported by content editor application 140 according to embodiments herein. As shown, a respective computer user 108 uses mouse-controlled prompt 116 to select (e.g., click on) a corresponding toggle button in display region 112. In response to selecting display region 112, content editor application 140 initiates display of management window 103 and corresponding listing 120 in graphical user interface 150.

Listing 120 displays entries for each of multiple font styles. For example, the second row entry in listing 120 displays a presentation option 122 of “Agency FB Bold” and a corresponding sample view 126 associated with selected text “Ring In The New Year with Lonewolff and BD Stye at the Pacific Coast Amphitheater.” In the context of the present example, lack of status information 124 (next to the font name) indicates that the font style is an active presentation option 146 registered with the operating system 142. Note that the listing 120 can be modified to include appropriate status information 124 (e.g., the word “active”) indicating that the font style is currently active. Lack of any status information in this example indicates to the computer user 108 that the font is currently activated.

The third row entry of listing 120 includes a presentation option 122 of “Algerian Regular,” status information 124 (e.g., the word “inactive” to indicate that the presentation option 122 is currently inactivated), and a corresponding sample view 126 (e.g., selected text “Ring In The New Year with Lonewolff and BD Stye at the Pacific Coast Amphitheater”). Accordingly, a computer user 108 can easily identify that the font style (e.g., Algerian Regular) is inactive and how the selected text (e.g., the sample view of “Ring In The New Year with . . . ”) would appear in such a font style.

To apply a selected font to the content 114, the user 108 can click on the “select” button displayed in listing 120.

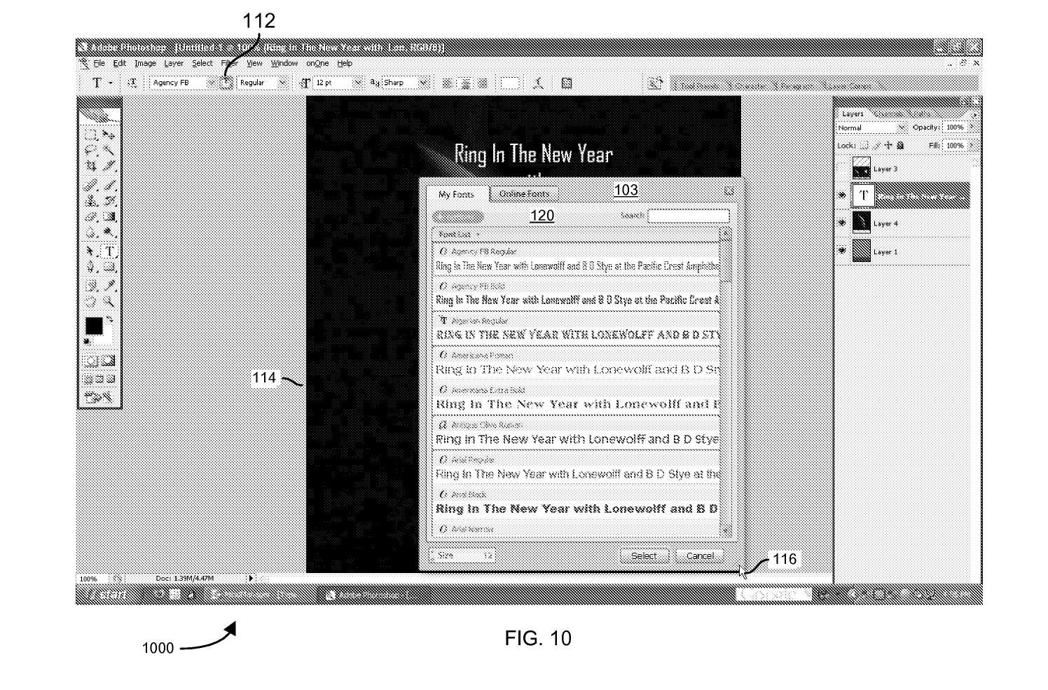

Assume in the present example of FIG. 9 that the user expands a size of management window 103 by clicking and dragging a corner of the management window 103 down and to the right. In response to the input, the content editor application 140 expands the management window 103 as shown in screenshot 1000 of FIG. 10. Note that expanding a size of the management window 103 enables the computer user 108 to simultaneously view more presentation options in listing 120.

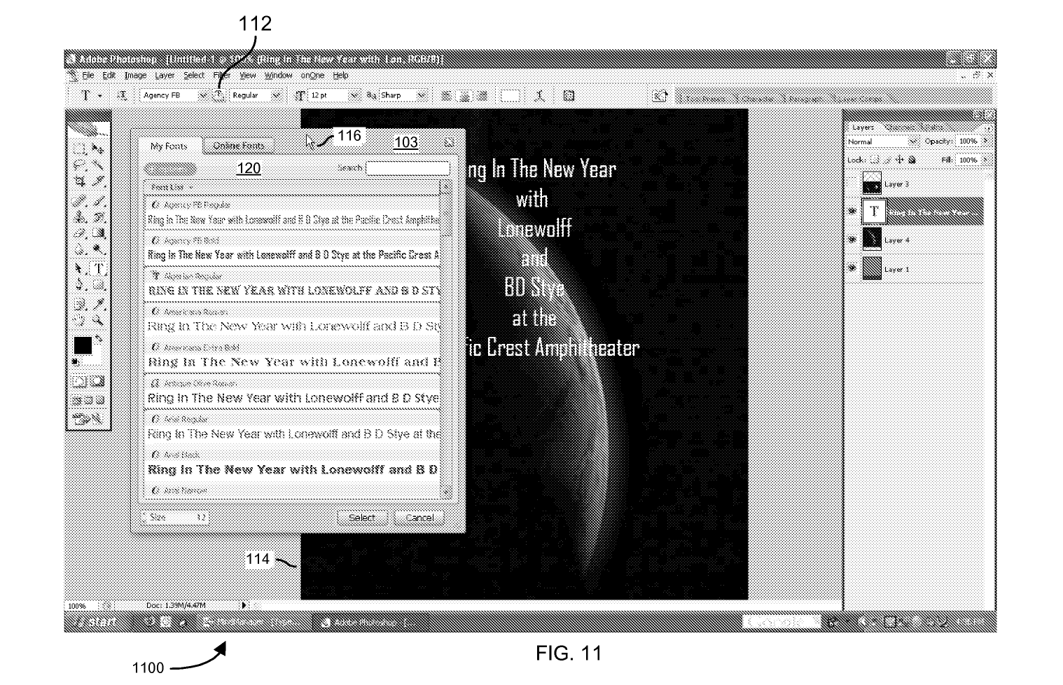

Assume in the present example screenshot 1000 of FIG. 10 that the user clicks on the management window 103 and drags the management window to the left of display screen 130. In response to this input, the content editor application 140 initiates movement of the management window 103 to the left as shown in screenshot 1100 of FIG. 11. This enables the computer user 108 to view portions of content 114 previously blocked by management window 103.

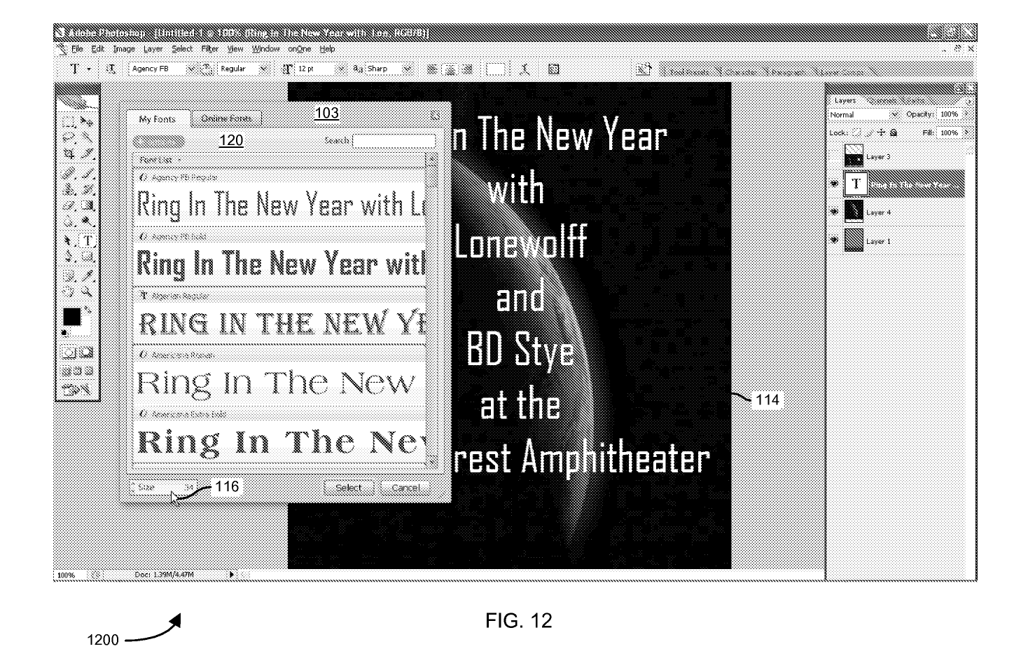

FIG. 12 is a screenshot 1200 illustrating an ability to resize characters according to embodiments herein. In response to selection of a larger font size such as 34 (from an original font size of 12) in the present example, the content editor application 140 initiates enlarging the size of characters in sample view of management window 103 and/or characters associated with content 114 on display screen 130.

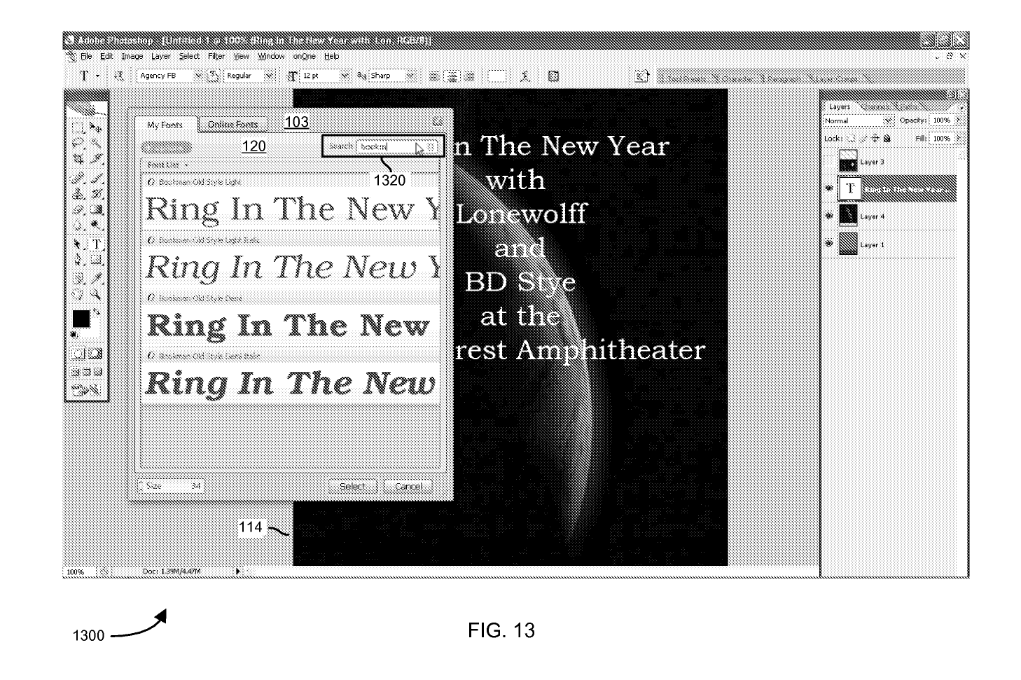

FIG. 13 is a screenshot 1300 illustrating an ability to search for different presentation options according to embodiments herein. In response to typing “bookm” in search field 1320, the content editor application 140 initiates display of only fonts in listing 120 that match this search criteria. In this example, there are four different Bookman font styles that satisfy the search criteria “bookm.” Providing this search functionality enables the computer user 108 to easily view specified font styles without having to scroll down a long pull-down menu.

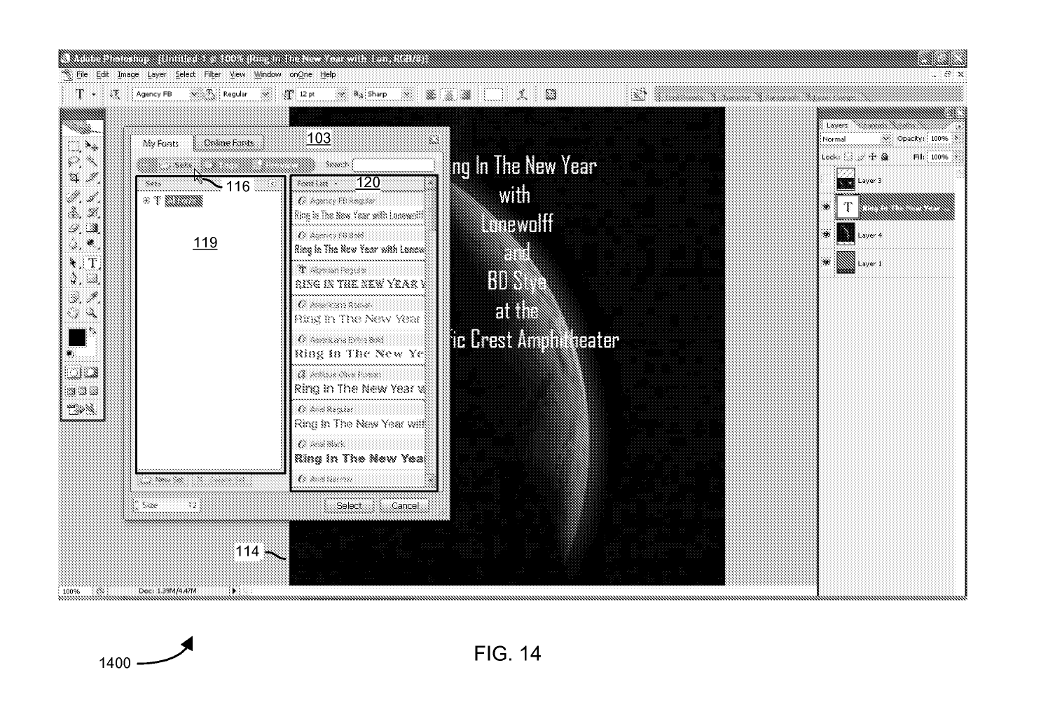

FIG. 14 is a screenshot 1400 illustrating an ability to save font styles (e.g., presentation options) in different folders according to embodiments herein. In the context of the present example, the computer user 108 selects “All Fonts” in folders 119 of management window 103. In response to receiving this input, the content editor application 140 highlights the All Fonts folder and displays contents of this selected folder in listing 120. Thus, this indicates to the computer user 108 the different font styles in listing 120 that are available from the selected “All Fonts” folder. Accordingly, the computer user 108 can select a folder and view different presentation options in the selected folder for selective application to content 114.

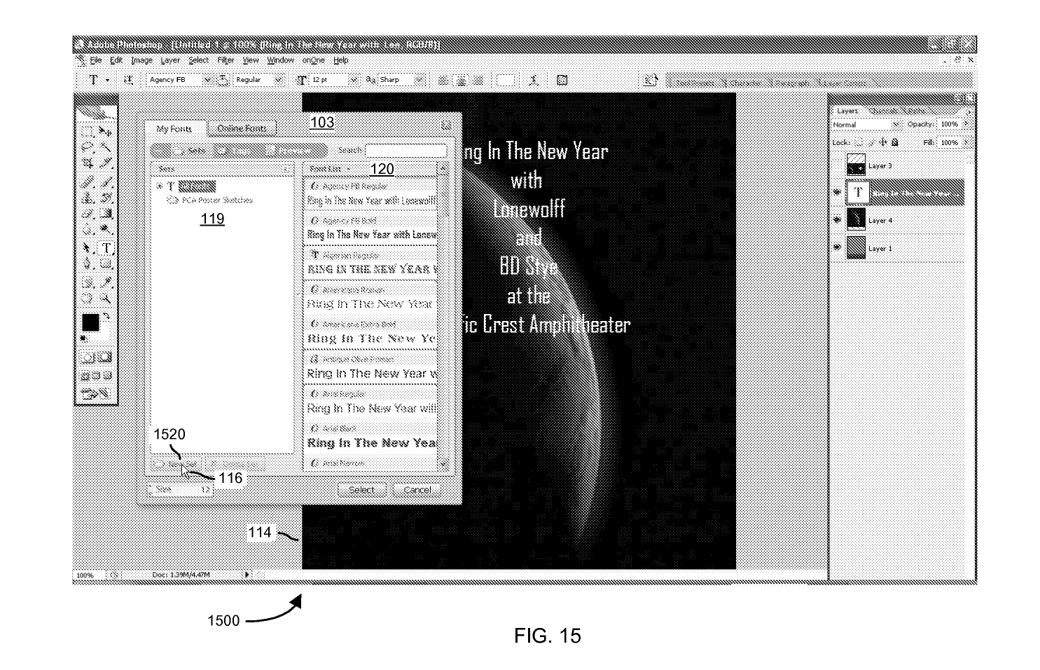

FIG. 15 is a screenshot 1500 illustrating an ability to create a new folder (e.g., set, group, etc.) for saving font styles (e.g., presentation options) according to embodiments herein. In the context of the present example, via prompt 116, the user 108 clicks on display region 1520 (e.g., New Set button). This creates a new folder for naming by the computer user 108. In the context of the present example, the computer user 108 names the new folder “PCA Poster Sketches.”

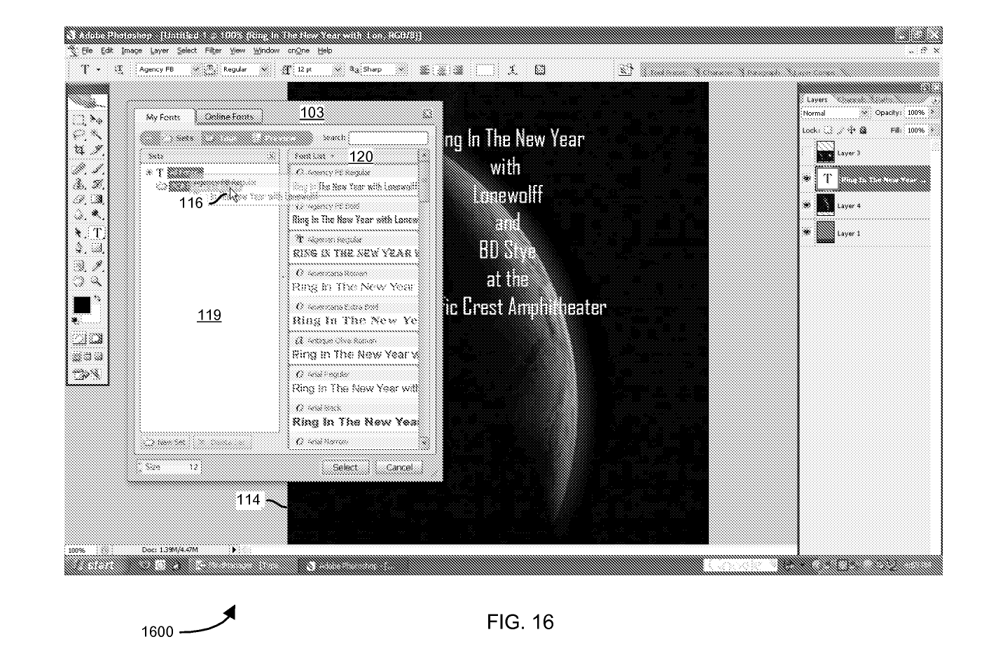

FIG. 16 is a screenshot 1600 illustrating an ability to populate a corresponding folder according to embodiments herein. In the context of the present example, the computer user 108 utilizes the prompt 116 to drag and drop the first presentation option (e.g., “Agency FB Regular”) from listing 120 to the newly created folder (e.g., “PCA Poster Sketches”) displayed in management window 103. In response to this input (e.g., dragging and dropping, cut and paste, etc.), the content editor application 140 adds the font style(s) to the newly created folder (e.g., PCA Poster Sketches folder). In one embodiment, the content editor application 140 maintains a pointer for each presentation option in the folder to indicate where a corresponding presentation option (e.g., “Agency FB Regular” or file supporting this font style) is stored in a local file system or at a remote location over a network.

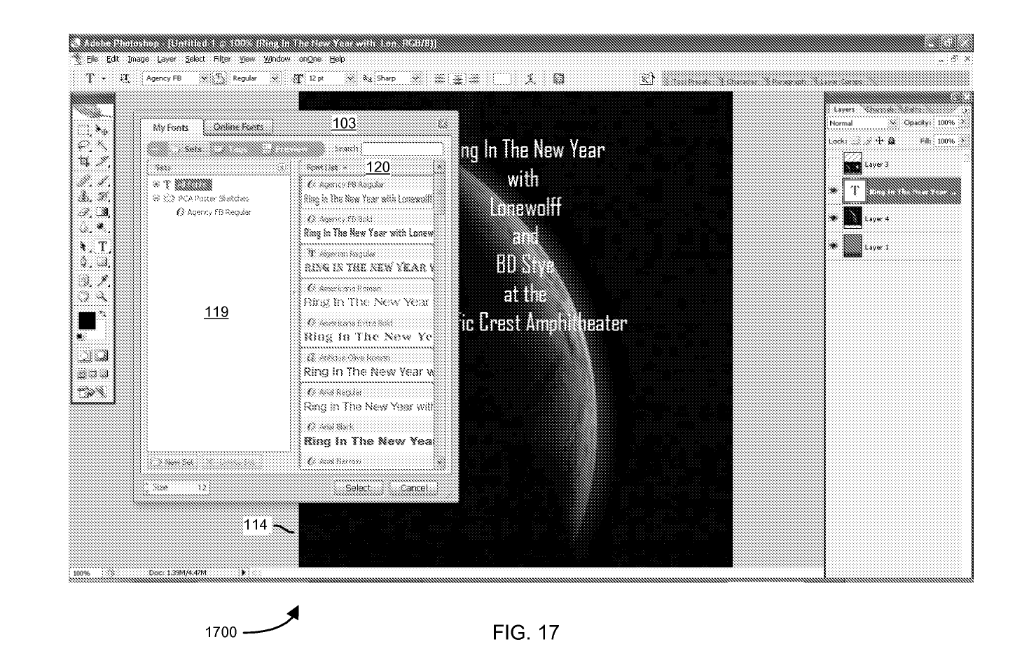

FIG. 17 is a screenshot 1700 illustrating an appearance of management window 103 after adding the “Agency FB Regular” presentation option to the newly created “PCA Poster Sketches” folder according to embodiments herein. Because the PCA Poster Sketches folder happens to be open, the content editor application 140 initiates display of management window 103 to include the newly created folder (e.g., PCA Poster Sketches folder) and the newly added presentation option (e.g., “Agency FB Regular”).

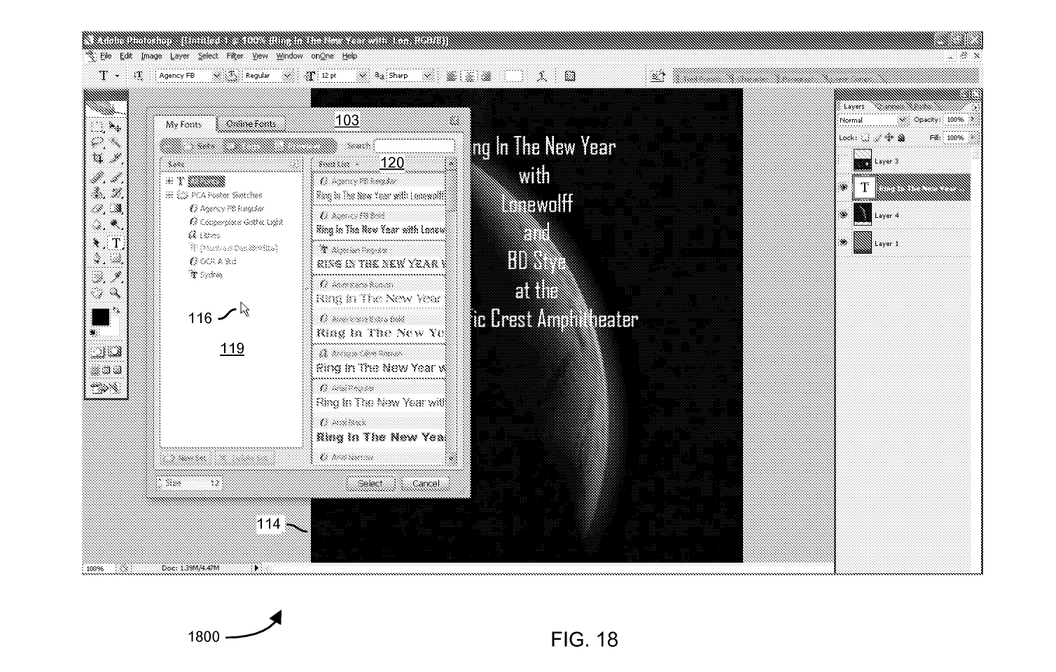

FIG. 18 is a screenshot 1800 illustrating an appearance of management window 103 after the respective computer user 108 adds several other presentation options according to embodiments herein. For example, the computer user 108 drags and drops Copperplate Gothic Light, Lithos, Montreal DemiBoldIta, OCR A Standard, and Sydnie presentation options for inclusion in the newly created PCA Poster Sketches folder. Accordingly, because the PCA Poster Sketches folder is open, these newly added presentation options appear beneath the PCA Poster Sketches folder. Note that the selection of these additional presentation options can occur as a bulk selection or as subsequent individual selection transactions. Since the All Fonts folder is still selected, listing 120 continues to display the presentation options stored in the All Fonts folder.

In addition to adding presentation options to a folder, note that the management window 103 enables a respective computer user 108 to remove presentation options from a folder as well.

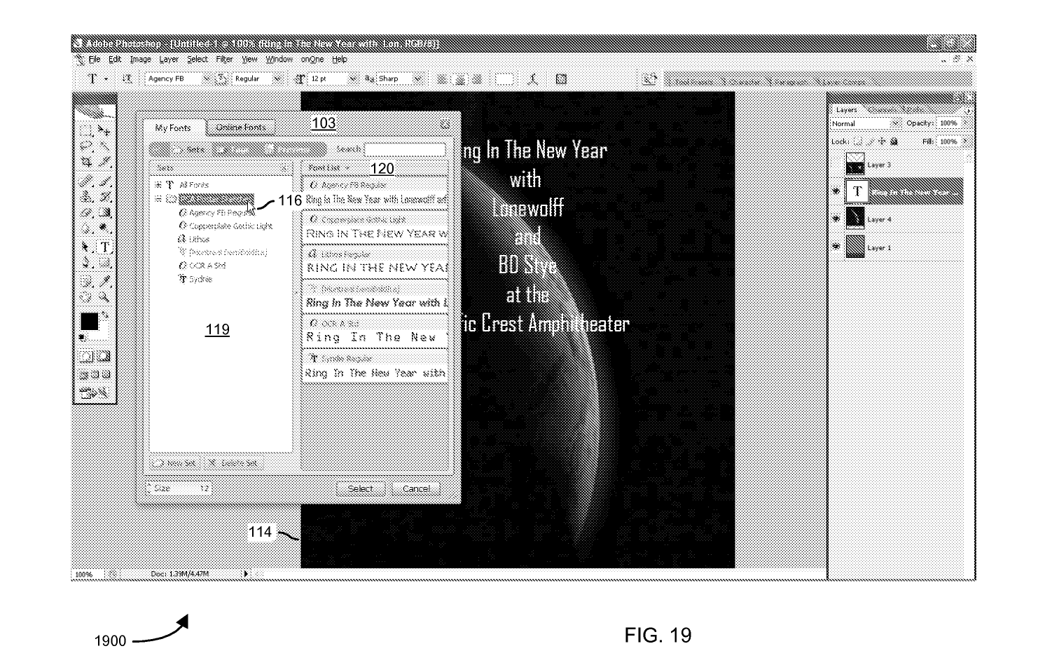

FIG. 19 is a screenshot 1900 illustrating an appearance of management window 103 after selection of the newly created folder (e.g., the PCA Poster Sketches folder) according to embodiments herein. As shown, in response to selection of this folder, the content editor application 140 initiates display of each presentation option in listing 120 of management window 103. The PCA Poster Sketches folder is highlighted to indicate the current selection. As previously discussed, the computer user 108 can view a sample of the presentation options in the selected folder and potentially apply any of the presentation options to content 114 on display screen 130. Note that the computer user 108 can select the “All Fonts” folder again to view all available fonts in listing 120 again.

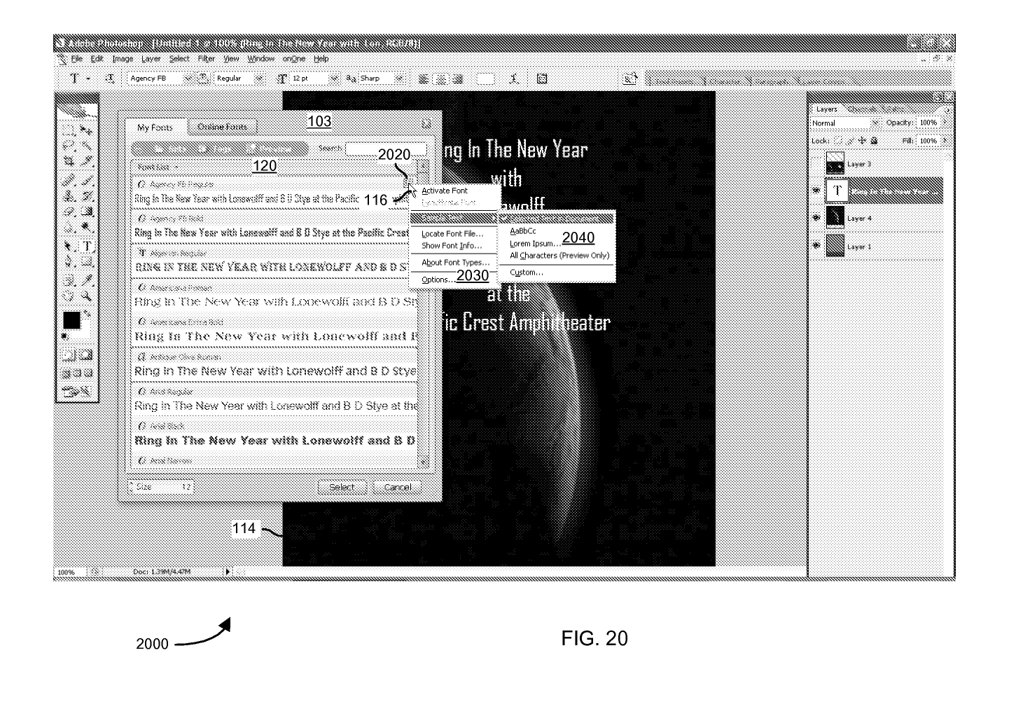

FIG. 20 is a screenshot 2000 illustrating a display of management window 103 after selection of the “All Fonts” folder and clicking on preview button 2010 according to embodiments herein. As the computer user 108 moves the prompt 116 in a vicinity of an entry (e.g., in this example, Agency FB Regular) in listing 120. The content editor application 140 initiates display of a selectable preview button in display region 2020.

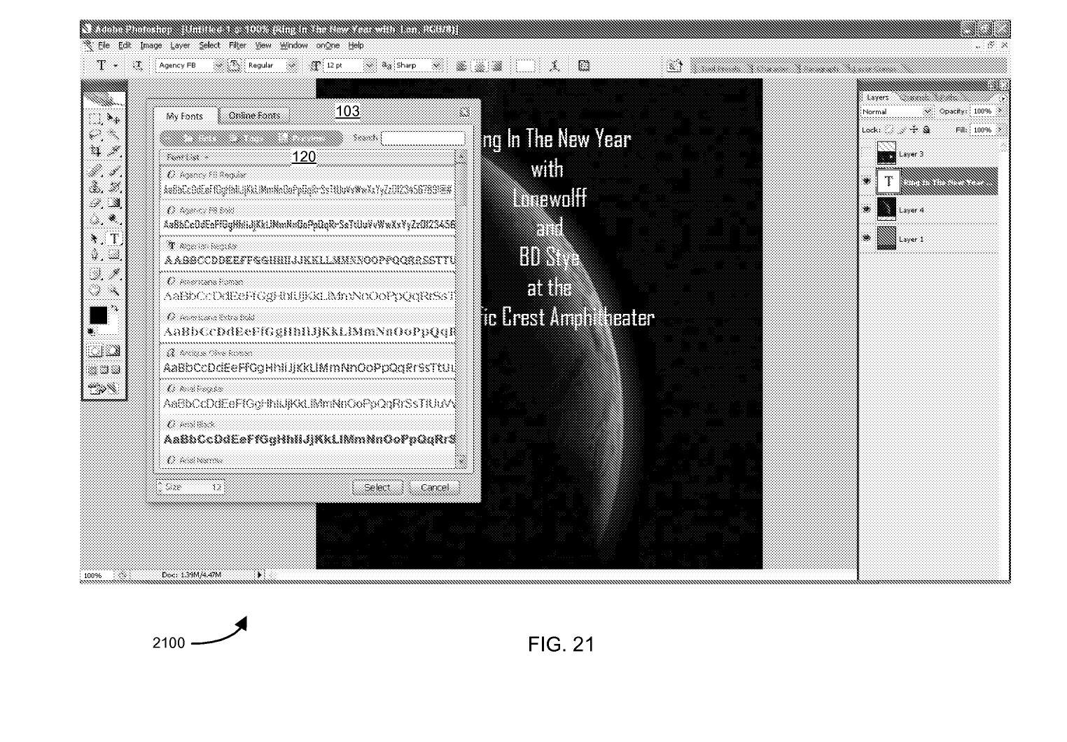

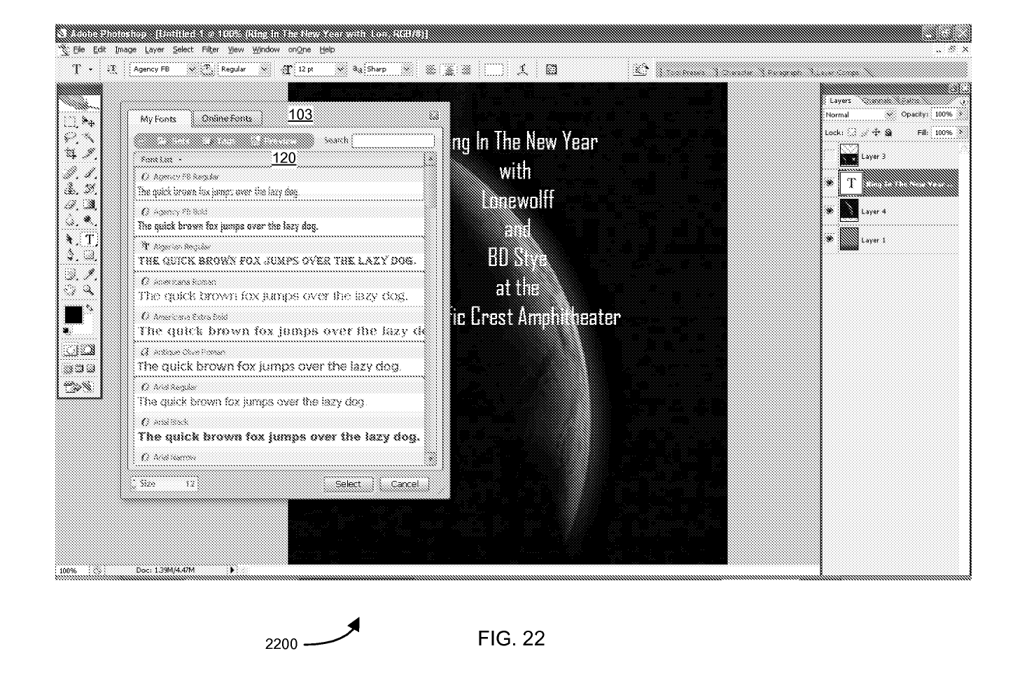

In response to detecting selection of (e.g., clicking on) display region 2020, the content editor application 140 initiates display of display region 2030 enabling application of different commands such as activation/deactivation of a respective font, changing of the type of sample text amongst the options specified in display region 2040 (see FIGS. 21 and 22), location of a font file supporting the corresponding entry, display of font information associated with a elected entry from listing 120, and a display of information about different font types.

FIG. 21 illustrates a display of listing 120 in management window 103 including a sample view of each respective selectable font applied to a set of characters such as the alphabet, numerals, etc. This occurs in response to receiving selection of “AaBbCc” in display region of FIG. 19. Accordingly, the content editor application 140 can receive input from a respective computer user 108 to change a current text string to which the corresponding presentation options are applied in the sample viewing in the listing 120. In response to receiving the input, the content editor application 140 modifies the sample view for each presentation option by applying the corresponding presentation option to a new text string (e.g., the alphabet, custom text, etc.) as selected by the computer user 108.

FIG. 22 illustrates a display of listing 120 in management window 103 including a sample view 126 of each respective selectable font applied to a custom character string supplied by the computer user 108 such as “The quick brown fox jumps over the lazy dog.” Accordingly, application of different display options presented in display region 2040 (as previously discussed with respect to FIG. 20) enables different types of sample viewing of font styles.

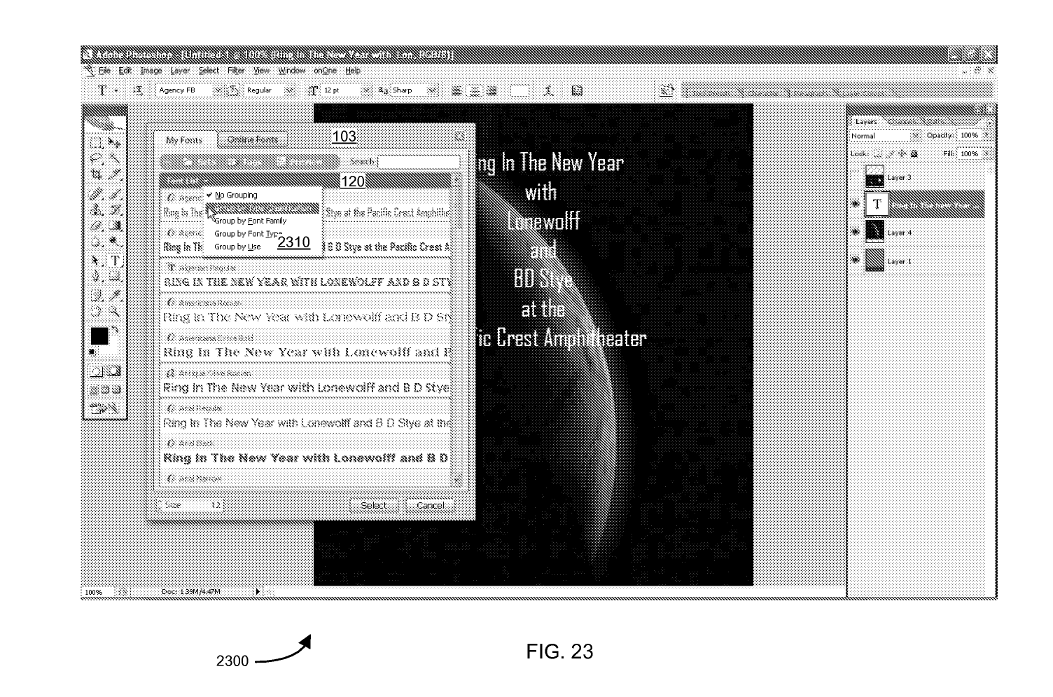

FIG. 23 is a screenshot 2300 illustrating a display of management window 103 after selection of the “All Fonts” folder and right clicking on the Font List bar in listing 120 according to embodiments herein. In response to detecting such an input, the content editor application 140 initiates display of display region 2310 including a list of different format settings to view the font entries according to groupings. For example, the computer user 108 can select the no grouping option (e.g., the previous setting) in which the fonts are presented as one big group in listing 120 in alphabetical order as shown. The computer user 108 can select the “Group by Type Classification” (e.g., currently selected option) to view the fonts in groups classified by type. Other selectable classifications (as identified by options in display region 2310) include grouping by font family, grouping by font type, and grouping of fonts by use.

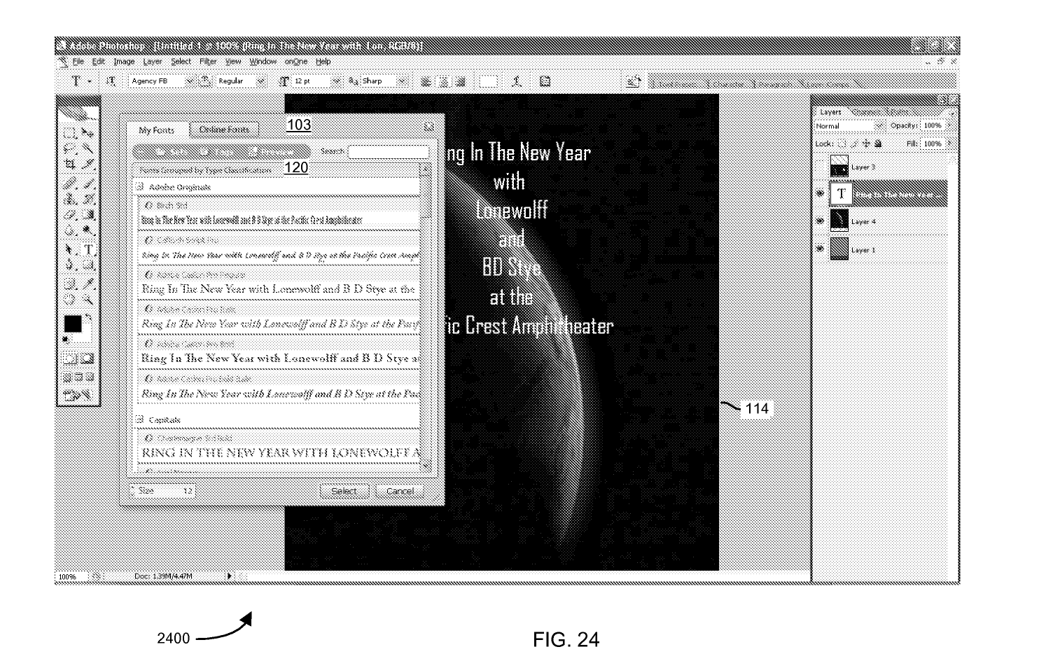

FIG. 24 is a screenshot 2400 illustrating an example display of management window 103 after selection of the “Group by Type Classification” according to embodiments herein. In response to detecting further input such as the user 108 clicking on the expand/collapse buttons associated with each respective group, the content editor application 140 initiates expanding and collapsing of the different groupings so that the user can more easily find and/or compare different available fonts for selective application to the content 114. Accordingly, embodiments herein include enabling display of a set of presentation options based on a selected classification from multiple different applicable classifications and partitioning and presenting of presentation options in the listing 120 according to the selected classification type.

Note that techniques herein are well suited for use in content editor applications such as those that support creating, modifying, managing, and/or displaying of content. However, it should be noted that embodiments herein are not limited to use in such applications and that the techniques discussed herein are well suited for other applications as well.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A method comprising:
initiating display of available presentation options in a listing for selective application to content currently being edited on a display screen, wherein the available presentation options are displayed in a first region of the display screen;
initiating display of a folder on the display screen along with the listing, wherein the folder is selectable and, upon selection, the folder displays individually-selectable identities of presentation options included in the folder for selective application to the content currently being edited on the display screen; and
receiving selection of a subset of presentation options chosen from the available presentation options in the listing, the selection including identities of presentation options from the listing to be included in the folder
wherein the display of available presentation options is within an image editor application.

2. (canceled)

3. A method as in claim 1, wherein the presentation options are font styles for selective application to a grouping of text associated with the content currently being edited on the display screen.

4. (canceled)

5. A method as in claim 1 further comprising:
for each identity of a corresponding presentation option in the folder, providing a sample preview in the first region of the display screen to indicate how the content on the display screen would appear if the corresponding presentation option in the folder were applied to the content on the display screen.

6. A method as in claim 1 further comprising:
initiating display of the folder in a hierarchy of multiple folders that track different subsets of presentation options selected from the available presentation options; and
enabling a viewer to selectively view identities of presentation options in each of the multiple folders.

7. A method as in claim 1, wherein receiving the selection includes:
receiving first input from a viewer selecting a first presentation option from the available presentation options in the listing;
in response to receiving the first input, initiating inclusion of the first presentation option in the folder;
receiving second input from a viewer selecting a second presentation option from the available presentation options in the listing; and
in response to receiving the second input, initiating inclusion of the second presentation option in the folder.

8. A method as in claim 1 further comprising:
in response to detecting dragging and dropping of a given presentation option from the available presentation options to the displayed folder, updating the folder to include the identity of the given presentation option.

9. A method as in claim 1 further comprising:
in response to receiving selection of the folder amongst multiple displayed folders, initiating display of identities of presentation options stored in the folder; and
enabling a viewer to selectively view identities of presentation options in each of the multiple folders for selective application to the content being currently edited on the display screen.

10. A method as in claim 9 further comprising:
allocating a portion of the display screen to enable searching for particular presentation options in the folder;
receiving search criteria;
initiating display of a subset of presentation options in the folder that satisfy the search criteria; and
for each of the presentation options in the folder, providing a sample view in the listing, the sample view in the listing indicating how the content on the display screen would appear if a corresponding presentation option in the folder were applied to the content on the display screen.

11. A method comprising:
initiating display of a window on a display screen, the window including a first display region and second display region;
populating the first display region of the window to include multiple folders, each folder selectable to present a corresponding set of individually-selectable presentation options for selective application to content currently being edited in a third display region on the display screen; and
in response to receiving selection of a given folder of the multiple folders in the first display region, populating the second display region of the window to include a sample view for each presentation option of the corresponding set of presentation options in the given folder, the sample view for each respective presentation option including a copy of the content displayed according to the respective presentation option
wherein the window on the display screen is of an image editor application.

12. (canceled)

13. A method as in claim 12 further comprising:
receiving selection of a particular presentation option associated with the given folder in the second display region, the particular presentation option being one of multiple font styles stored in the given folder; and
in response to the selection of the particular presentation option, initiating modification of a grouping of text associated with the content in the third display region according to the particular presentation option.

14. A method as in claim 11, wherein populating the second display region includes:
for each presentation option in the given folder, populating the second display region to include a sample view of how the content on the display screen would appear if a corresponding presentation option in the given folder were applied to the content on the display screen.

15. A method as in claim 11, wherein the given folder is a first folder and wherein populating the first display region of the window to include multiple folders includes initiating display of the first folder and a second folder in the first display region, the method further comprising:
receiving selection of a particular presentation option associated with in the first folder as displayed in the second display region;
receiving a command to copy the particular presentation option for inclusion in the second folder; and
in response to receiving the command, updating the second folder to include the particular presentation option selected from the first folder.

16-20. (canceled)

21. A computer program product including a computer-readable storage medium having instructions stored thereon for processing data information, such that the instructions, when carried out by a processing device, enable the processing device to perform the operations comprising:
initiating display of available presentation options in a management window for selective application to content currently being edited on a display screen;
receiving selection of a subset of presentation options chosen from the available presentation options in the management window;
maintaining the management window to include a folder to include identities of presentation options associated with the selection, wherein the folder is selectable and, upon selection, the folder displays individually-selectable identities of presentation options included in the folder for selective application to the content currently being edited on the display screen; and
initiating display of the folder in the management window on the display screen along with the available presentation options to enable selection of the folder for including the subset of presentation options
wherein the display of available presentation options is within the management window of an image editor computer program product.

22. A computer program product as in claim 21 further supporting operations of:
prior to receiving the selection, receiving a command to create the folder for display in the management window; and
in response to receiving the command, initiating creation of the folder for viewing in the management window on the display screen.

23-24. (canceled)

25. A computer program product as in claim 21 further supporting operations comprising:
for each identity of a presentation option in the folder, providing a sample preview in the second region of the management window to indicate how the content on the display screen would appear if a corresponding presentation option in the folder were applied to the content on the display screen.

26. A computer program product as in claim 21 further supporting operations comprising:
initiating display of the folder in a hierarchy of folders displayed in the management window, the folders tracking different sets of presentation options selected from the available presentation options in the management window; and
enabling a viewer to selectively view identities of presentation options in each of the multiple folders.

27. A computer program product as in claim 21, wherein receiving the selection comprises:
receiving first input from a viewer selecting a first presentation option from the available presentation options;
in response to receiving the first input, initiating inclusion of the first presentation option in the folder;
receiving second input from a viewer selecting a second presentation option from the available presentation options; and
in response to receiving the second input, initiating inclusion of the second presentation option in the folder.

28. A computer program product as in claim 21 further supporting operations comprising:
in response to detecting dragging and dropping of a given presentation option from the available presentation options to the folder, updating the folder to include the identity of the given presentation option.

29. A computer program product as in claim 21 further supporting operations comprising:
in response to receiving selection of the folder amongst multiple displayed folders, initiating display of identities of presentation options stored in the folder; and
enabling a viewer to selectively view identities of presentation options in each of the multiple folders for selective application to the content being currently edited on the display screen.

30. A computer system that supports selection and paste operations, the computer system comprising:
a processor;
a memory unit that stores instructions associated with an application executed by the processor; and
an interconnect coupling the processor and the memory unit, enabling the computer system to execute the application and perform operations of:
initiating display of available presentation options in a listing for selective application to content currently being edited on a display screen, wherein the available presentation options are displayed in a first region of the display screen;
initiating display of a folder on the display screen along with the listing, wherein the folder is selectable and, upon selection, the folder displays individually-selectable identities of presentation options included in the folder for selective application to the content currently being edited on the display screen; and
receiving selection of a subset of presentation options chosen from the available presentation options in the listing, the selection including identities of presentation options from the listing to be included in the folder
wherein the application is an image editor application and the display of available presentation options is within the image editor application.

31. The method as in claim 1 further comprising:
initiating display of a first sample view in the listing for a first presentation option of the available presentation options, the first sample view in the listing displaying a first copy of the content according to a font format style as specified by the first presentation option;
initiating display of a second sample view in the listing for a second presentation option of the available presentation options, the second sample view in the listing displaying a second copy of the content according to a font format style as specified by the second presentation option.

32. The method as in claim 31 further comprising:
providing a visual distinction between the first presentation option in the listing and the second presentation option in the listing, the visual distinction indicating that the first presentation option is currently activated and registered with a corresponding operating system and that the second presentation option is inactivated and not currently registered with the corresponding operating system.

33. The method as in claim 31 further comprising:
in response to receiving input, adjusting a font size of text in the first sample view and the second sample view.

34. The method as in claim 31 further comprising:
in response to detecting dragging and dropping of the first presentation option from the available presentation options in the listing to the displayed folder, updating the folder to include an identity of the first presentation option; and
in response to detecting dragging and dropping of the second presentation option from the available presentation options in the listing to the displayed folder, updating the folder to include an identity of the second presentation option.

35. The method as in claim 31 further comprising:
in response to receiving selection of the first presentation option from the listing, modifying the content on the display screen in accordance with a font style as specified by the first presentation option.

36. The method as in claim 31 further comprising:
in response to receiving selection of an identity of the first presentation option displayed in the folder, modifying the content on the display screen in accordance with a font style as specified by the first presentation option.

37. The method of claim 1, wherein the individually-selectable identities of presentation options have an associated status of active or inactive displayed on the display screen.
